(19) United States
(12) Patent Application Publication
(10) Pub. No.: US 2026/0100084 A1
(43) Pub. Date: Apr. 9, 2026

(54) DOCUMENT FRAUD PREVENTION SYSTEM

(71) Applicant: American Express Travel Related Services Company, Inc., New York, NY (US)

(72) Inventors: Ashwin Upamanyu Dev, Bengaluru (IN); Ananya Agarwal, Bengaluru (IN); Sourajit Mukherjee, Bengaluru (IN); Shivshankar Reddy, Bangalore (IN); Sriranjani Ramakrishnan, Bengaluru (IN); Sai Kiran Peketi, Bengaluru (IN); Himanshu Sharad Bhatt, Bengaluru (IN); Abhishek JHA, Gurugram (IN); Radhakrishnan G, Guragon (IN)

(21) Appl. No.: 18/906,234

(22) Filed: Oct. 4, 2024

(51) Int. Cl. G07D 7/206

(52) U.S. Cl. CPC G07D 7/206

(57) ABSTRACT

Disclosed are various embodiments for verification of legitimate documents and identification of fraudulent documents using machine learning and artificial intelligence. A computing device can identify with a machine learning algorithm one or more fields from within an unverified document associated with an entity. The computing device can identify a verified document corresponding to the unverified document based at least in part on the entity. Then, the computing device can compare the one or more unverified fields of the unverified document to one or more verified fields of the verified document. Finally, the computing device can determine whether the unverified document is fraudulent based at least in part on the comparison of the one or more unverified fields to the one or more verified fields.

### BACKGROUND

Many businesses require customers to upload documents for a variety of purposes. For example, a banking institution may require a customer to upload financial statements as part of a credit application. However, there has been a substantial increase in document fraud in bank statements and loan applications in recent years. The results have been millions lost where applications were approved using fraudulent bank documents.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A and 1B are pictorial diagrams depicting the operation of the algorithm according to one of several embodiments of the present disclosure.

FIG. 2 is a drawing of a network environment according to various embodiments of the present disclosure.

FIGS. 3A-7 are flowcharts illustrating examples of functionality implemented as portions of an application executed in a computing environment in the network environment of FIG. 2 according to various embodiments of the present disclosure.

### DETAILED DESCRIPTION

Disclosed are various approaches for verification of legitimate documents and identification of fraudulent documents using machine learning and artificial intelligence. Often, businesses require customers to upload documents through a web application or portal in order to complete online verifications of various information. For example, a banking institution may require a customer to upload financial statements or photographs of government identity documents (e.g., a driver's license) as part of a credit application. However, digital copies of documents can be easily edited by individuals for fraudulent purposes. For example, a legitimate bank statement could be edited to show a higher account balance than exists or to create fake bank statements representing non-existent accounts. As another example, photographs of legitimate driver's licenses could be digitally altered to create a fake driver's license to establish a fraudulent identity for an individual. In yet another example, a scan of a check for online deposit could be modified to show an amount for deposit than what was originally provided. Institutions have lost significant sums of money over the years due to use of fraudulent documents by new or existing customers.

Detection of fraudulent documents can be difficult or impossible with the naked eye. When reviewing a digital document, a human may be unable to detect subtle indicators of fraud or tampering. For example, the human eye cannot detect the pixel-level alignment of data in a table, while a computer can detect such imperceptible misalignments. Small, subtle, or imperceptible misalignments of data in a table can indicate that the document has been altered and may be fraudulent.

In a similar example, a human may not be able to visually detect minor misplacements of content within a document. For example, an altered document might have text imperceptibly off-center from a vertical or horizontal axis (e.g., too high, too low, or too far to the left or the right from the correct position). As another example, an altered document might have a graphic that is slightly misplaced (e.g., too high or low or too far to the left or right from its correct position), slightly out of proportion (e.g., too big or too small), etc. These errors could be too small to be visually perceptible to a human but could be detectable by a computer.

In another example, a visual inspection of a digital document does not allow for the analysis of metadata. However, a computer can analyze the metadata embedded within a file. For example, a document representing a bank statement could have a date of Aug. 1, 2025. However, a human could not read the metadata embedded within the file that includes information such as when the document was created. In contrast, a computer could read the metadata to determine that the document was created on Aug. 5, 2025 (after the date printed on the document) and therefore is likely to be fraudulent.

As discussed in the following paragraphs and illustrated in the accompanying drawings, the various embodiments of the present disclosure allow for the analysis of documents using a variety of factors and mechanisms. These factors and mechanisms include both the previously described examples as well as additional factors and mechanisms. As a result, the various embodiments of the present disclosure allow for computers to detect altered or edited digital documents in a manner that cannot be performed by a human being for the purposes of fraud detection and prevention.

Accordingly, various embodiments of the present disclosure relate to a machine learning and artificial intelligence model for detection of fraudulent documents. The machine learning model is trained to identify numerous fraud indicators in digital documents which are undetectable to the human eye. The use of the machine learning model allows for an adaptable process of fraud detection, where the model continues to learn new indicators of fraud based on its ability to use historical data and documents which it has already analyzed. Thus, while improving the ability of an institution or entity to detect a fraudulent document, the machine-learning model also saves time and resources for an entity by reducing the time and labor needed to review each document from countless hours to a matter of minutes or less.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

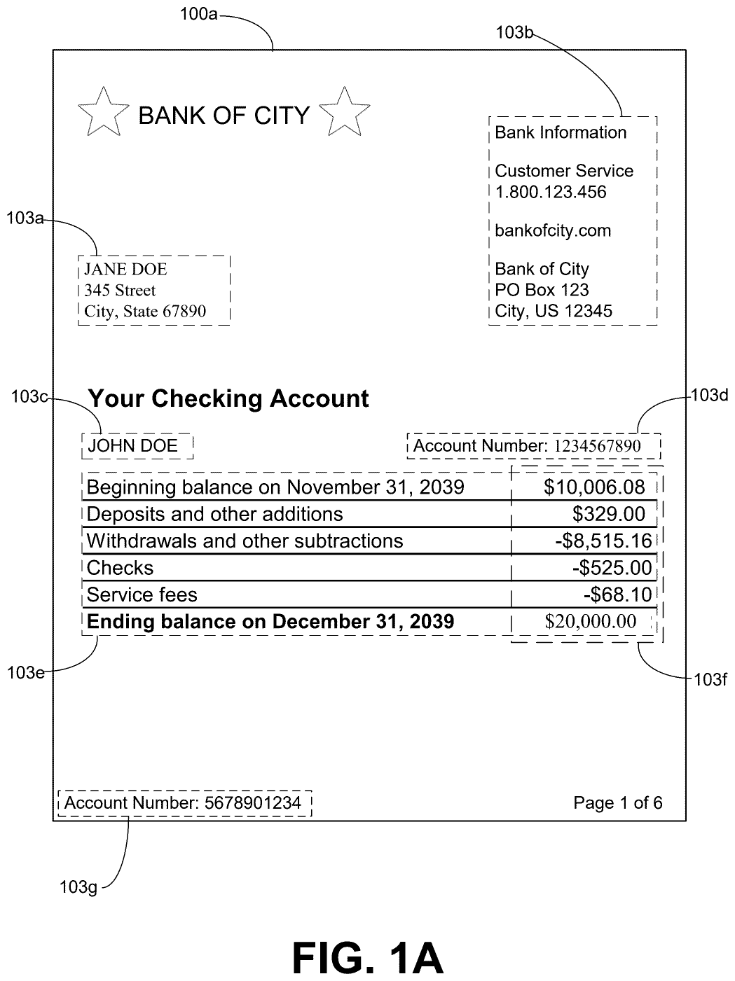

In FIG. 1A, shown is a document 100 which can be submitted by a user. The document 100 can be associated with an entity. For example, as shown in FIG. 1A, the document 100a comprises a financial statement for a checking account associated with a hypothetical entity “Bank of City.” However, according to various examples, the document 100 can be representative of other forms of documents as well. The document 100a of FIG. 1A has a plurality of fields 103 which can be detected. In the example of FIG. 1A, field 103a includes information such as the name and address of the customer. Field 103b includes information about Bank of City as shown. Field 103c repeats the customer name, and field 103d introduces an account number associated with the customer. Fields 103e and 103f show the various line items and respective values which impact the total balance of the account. Finally, in field 103g, the account number associated with the customer is repeated. The document 100a can have various discrepancies within the fields 103 which can be detected and marked as indications of fraud. For illustrative purposes, several potential discrepancies have been added to the example of FIG. 1A.

Next, at FIG. 1B, shown is a comparison of the document 100a from FIG. 1A to a verified document 106a. In some examples, a verified document 106 can be identified based at least in part on the entity associated with the document 100. For example, in FIG. 1B, the document 100a is associated with Bank of City. Thus, the verified document 106a in FIG. 1B is also associated with Bank of City. The verified document 106 can have one or more verified fields 109. The verified fields 109 can correspond to the fields 103 of the document 100. In some examples, the verified document 106 is an example of a document which has previously been determined to be legitimate and not fraudulent. The verified document 106 can serve as a template or form for a comparison of the document 100 to determine whether the document 100 is fraudulent.

As shown in FIG. 1B, the verified fields 109 can correspond to the fields 103. For example, verified field 109a corresponds to field 103a. One way to determine that a field 103 corresponds to a verified field 109 is by the location of the field 103 relative to the location of the verified field 109, the content of the fields 103, etc. In the example of FIG. 1B, field 103a and verified filed 109a both are in the same relative position on the page, and both include a customer name and address. Similarly, both field 103b and verified field 109b include information about the entity (e.g., Bank of City). The comparison of document 100a to the verified document 106a can include an analysis of a variety of different factors. In FIG. 1B, the comparison of the document 100a to the verified document 106a resulted in the identification of a number of fields 103 which contain potential indications of fraud (see fields 103 outlined in dashed boxes). For example, the comparison identified that the font typically used for verified field 109a does not match the font used in field 103a. Similarly, the font of the account number in field 103d does not match the font of the corresponding verified field 109d.

In some examples, the comparison can yield other factors which may be indicative of fraud. As shown in the example of FIG. 1B, an alignment of the values in field 103f does not match the alignment of the verified fields 109 of the verified document 106a. In some examples, the alignment of the fields 103 can be evaluated without a verified document 106 by comparing the pixel-level alignment of each of the respective values in the field 103. In the document 100a of FIG. 1B, the alignment of the ending balance does not match the alignment of the rest of the values in field 103f nor does it match the alignment of the verified fields 109 in the verified document 106a, nor does the font match. Further, an analysis of the content of field 103f would yield that the value for the ending balance does not correspond to the sum of the values listed for other line items in field 103f.

Finally, FIG. 1B shows that a content analysis of the document 100a can be performed which identifies fields 103 which are supposed to contain the same information. For example, in the verified document 106a, verified field 109d and 109e both contain the same account number associated with the customer. Similarly, verified fields 109a and 109c both contain the same name for the customer. However, when document 100a is processed, the machine-learning algorithm can identify that fields 103a and 103c contain different names, and fields 103d and 103g contain different account numbers. These inconsistencies can be indicators of fraud. While the differences and discrepancies in the document 100a of FIGS. 1A and 1B have been made highly visible for illustrative purposes, it is often the case that font differences, alignment differences, content differences, etc. are not readily apparent to the naked eye. Accordingly, the system described below provides for the detection of subtle indicators to identify fraud in digital documents.

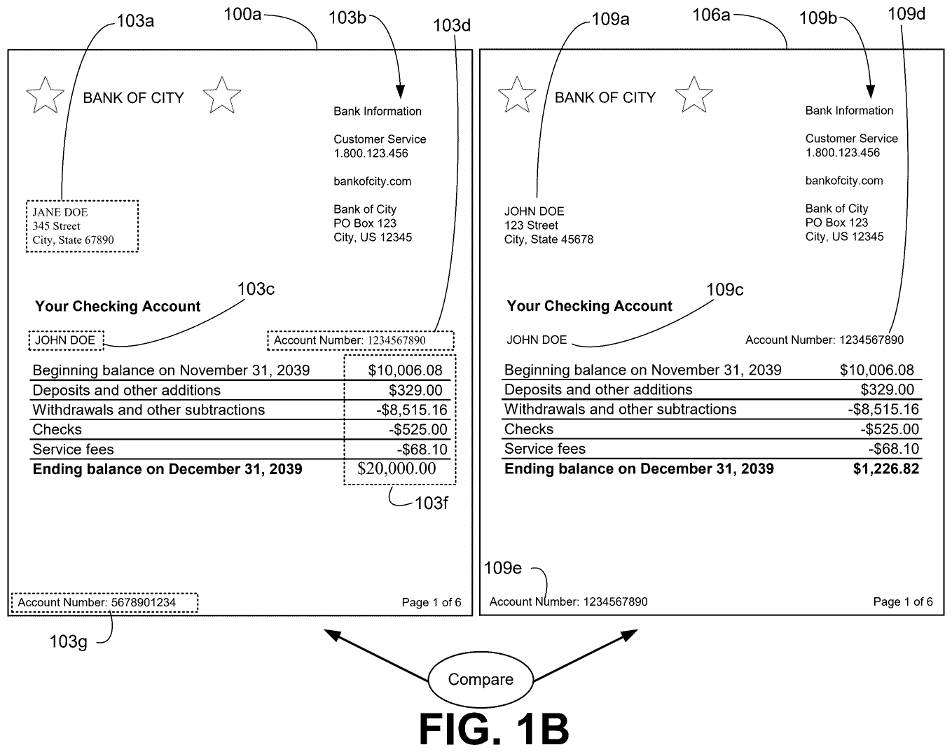

With reference to FIG. 2, shown is a network environment 200 according to various embodiments. The network environment 200 can include a computing environment 203 and a client device 206 which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a fraud detector application 213, and other applications, services, processes, systems, engines, or functionality not discussed in detail herein.

The fraud detector application 213 can be executed to receive and process documents 100 which have been submitted by users. The fraud detector application 213 can use a machine-learning model to perform a variety of analyses on a document 100 in order to identify indicators of fraud. For example, the fraud detector application 213 can perform a metadata analysis, a font analysis, a layout analysis, a content analysis, pattern recognition, duplicate detection, and other various analyses. In some examples, the fraud detector application 213 can be executed to identify a number of indicators of fraud, compare the number to a threshold, and determine whether a document is fraudulent or legitimate.

Also, various data is stored in a data store 216 that is accessible to the computing environment 203. The data store 216 can be representative of a plurality of data stores 216, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 216 is associated with the operation of the various applications or functional entities described below. This data can include documents 100 having fields 103 and metadata 219, verified documents 106 having verified fields 109, fraud indicators 223, user data 226, a negative library 229, and potentially other data.

The documents 100 can represent digital files, such as those that might be uploaded by a user. A document 100 can be in the form of a Portal Document Format (PDF), a word-processing file (e.g., a DOC file for MICROSOFT WORD®, a WPD file for ALLUDO WORDPERFECT®, etc.), an XML-based file format (e.g., a DOCX file for MICOSOFT WORD® or OPENOFFICE WRITER®, etc.), Rich Text Format (RTF), Hypertext Markup Language (HTML or HTM) files, or other digital file format suitable for storing a document. Documents 100 can be “native” or “born-digital” (e.g., having originated on a computer) or be scanned from a physical image. Each document 100 can contain various other data. For example, a document 100 can include information about the user who submitted the document 100 as well as information about an entity such as a bank, business, government, or other organization associated with the document 100. In some examples, the document 100 is representative of a bank statement, account summary, tax forms, documents used to identify an individual (e.g., driver's licenses, passports, utility bills, etc.), checks, or other documents 100. Each document 100 can include one or more fields 103 as well as metadata 219.

The fields 103 can represent different sections, tables, pictures, headers, footers, or other distinct portions of a document 100. Each field 103 can include a specific piece of information, and some fields 103 can be related fields 103 having the same or similar information as other fields 103. For example, a header and a footer of a document 100 can both include a customer name or an account number as an identifier of the document 100.

The metadata 219 can represent data about a document 100. Metadata 219 can include objects that provide information about the creation of the document 100 and its contents, the source of the data within the document 100, and various other behind-the-scenes data. Metadata 219 can be descriptive, structural, administrative, reference, statistical, legal, etc. In some examples, the metadata 219 can also include xmp and xref tables.

Verified documents 106 can represent digital files which were previously uploaded by a user and previously verified by the fraud detector application 213, or another verification process. A verified document 106 can be in the form of a Portal Document Format (PDF), a word-processing file (e.g., a DOC file for MICROSOFT WORD®, a WPD file for ALLUDO WORDPERFECT®, etc.), an XML-based file format (e.g., a DOCX file for MICOSOFT WORD® or OPENOFFICE WRITER®), Rich Text Format (RTF), Hypertext Markup Language (HTML or HTM) files, or other digital file format suitable for storing a document. Verified documents 106 can contain various data. For example, a verified document 106 can include information about the user who submitted the verified document 106 as well as information about an entity such as a bank, business, government, or other organization associated with the verified document 106. In some examples, the verified document 106 is representative of a bank statement, account summary, tax forms, identification documents that can identify an individual (e.g., driver's licenses, passports, utility bills, etc.), checks, or other documents. According to various examples, verified documents 106 correspond to documents 100 which have been uploaded by a user. For example, if the user uploads a bank statement associated with the hypothetical “Bank of City,” the corresponding verified document 106 could be another example bank statement associated with Bank of City. In some examples, a verified document 106 can be a form or template document representing a generic form of the document 100 submitted by a user. Verified documents 106 can include one or more verified fields 109.

The verified fields 109 can represent different sections, tables, pictures, headers, footers, or other distinct portions of a verified document 106. Each verified field 109 can include a specific piece of information, and some verified fields 109 can be related fields having the same or similar information as other verified fields 109. In some examples, verified fields 109 of a verified document 106 can correspond to the fields 103 of a document 100 because they are in similar relative locations, have similar content, serve a similar purpose, or have another relation.

The fraud indicators 223 can be representative of signs or indications that a document 100 has been altered or otherwise tampered with or that the document 100 has been forged or counterfeited. Numerous factors can qualify as fraud indicators 223. In some examples, fraud indicators 223 can include inconsistent or incorrect fonts, inconsistent or incorrect alignment or placement of content, or inconsistent or incorrect content within a document 100. In some examples, a fraud indicator 223 can include the presence of a duplicate of the document 100 within the data store 216. Fraud indicators 223 can further include a particular author, customer name, address, account number, or other marker appearing in a negative library 229.

User data 226 can be representative of any data associated with the user who submits the document 100. In some examples, the user data 226 includes information such as the name, address, account number, IP address, or various other identifying information about the user. In some examples, the user data 226 can be used to cross-check or verify information in a document 100.

The negative library 229 can represent a database or library of fraudulent documents and other information associated with the fraudulent documents. In some examples, the negative library 229 can include a list of authors, users, or originating IP addresses which are associated with past fraudulent activity. The negative library 229 can be managed by the verifier of the documents 100 or can be a shared library between numerous other verifying entities.

The client device 206 is representative of a plurality of client devices that can be coupled to the network 209. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, Blu-Ray® players, digital video disc (DVD) players, set-top boxes, and similar devices), a videogame console, or other devices with like capability. The client device 206 can include one or more displays 233 such as liquid crystal displays (LCDs), gas plasma-based flat panel displays, organic light emitting diode (OLED) displays, electrophoretic ink (“E-ink”) displays, projectors, or other types of display devices. In some instances, the display 233 can be a component of the client device 206 or can be connected to the client device 206 through a wired or wireless connection.

The client device 206 can be configured to execute various applications such as a client application 236 or other applications. The client application 236 can be executed in a client device 206 to access network content served up by the computing environment 203 or other servers, thereby rendering a user interface 239 on the display 233. To this end, the client application 236 can include a browser, a dedicated application, or other executable, and the user interface 239 can include a network page, an application screen, or other user mechanism for obtaining user input. The client device 206 can be configured to execute applications beyond the client application 236 such as email applications, social networking applications, word processors, spreadsheets, or other applications.

Next, a general description of the operation of the various components of the network environment 200 is provided. Although the following general description provides one example of the operation of the various components of the network environment 200, other operations or interactions are also encompassed by the various embodiments of the present disclosure.

To begin, a user can upload a document 100 for verification to a fraud detector application 213. The fraud detector application 213 can receive the document 100 and begin to perform one or more analyses to determine whether the document 100 includes any fraud indicators 223. In some embodiments, the fraud detector application 213 can determine which of several analyses to perform based at least in part on the type of document 100 which was received. In some examples, the fraud detector application 213 can be configured to execute one or more analyses based at least in part on instructions from an administrator.

The fraud detector application 213 can perform a metadata analysis of the metadata 219 of the document 100. The metadata analysis can result in the identification of a number of fraud indicators 223 which the fraud detector application 213 can use to determine whether the document 100 is fraudulent. In another analysis, the fraud detector application 213 can identify one or more fields 103 in the document 100 and analyze the fonts, layouts, contents, and other features of the fields 103. Such an analysis can result in the identification of another number of fraud indicators 223. In some examples, the fraud detector application 213 can identify a corresponding verified document 106 which can be used to perform a variety of comparisons with the document 100 in order to detect fraud indicators 223. According to various examples, the fraud detector application 213 can compare the document 100 and data from the document 100 against a negative library 229. By cross-checking various data against the negative library 229, the fraud detector application 213 can identify fraud indicators 223 which can then be used to determine whether the document 100 is fraudulent. In some examples, the fraud detector application 213 can perform a pattern-recognition analysis of the document to determine whether data in the document 100 has been manufactured or altered in some manner. For example, the identification of a series of repeating numbers or a pattern of whole or round numbers appearing in the document 100 can be indicative of manufactured data. The pattern-recognition analysis can result in another number of identified fraud indicators 223 for use in determining whether the document 100 is fraudulent.

After the necessary analyses have been completed, and different numbers of fraud indicators 223 have been identified, the fraud detector application 213 can compare a total number of fraud indicators 223 identified to a threshold. According to various examples, the threshold is a predetermined value which is uniform across different documents 100 and analyses. However, the threshold can also be determined based at least in part on the type of document 100, the analysis performed, the weight of respective fraud indicators 223, or other factors. The threshold, in some examples, can be zero for some fraud indicators 223. In some examples, the threshold can be a non-zero integer. The fraud detector application 213 can determine whether the document 100 is fraudulent based at least in part on the total number of fraud indicators 223 compared to the threshold. For example, if the number of identified fraud indicators 223 exceeds the threshold, the fraud detector application 213 can flag the document 100 as fraudulent. If the number of identified fraud indicators 223 does not exceed the threshold, the fraud detector application 213 can flag the document 100 as verified.

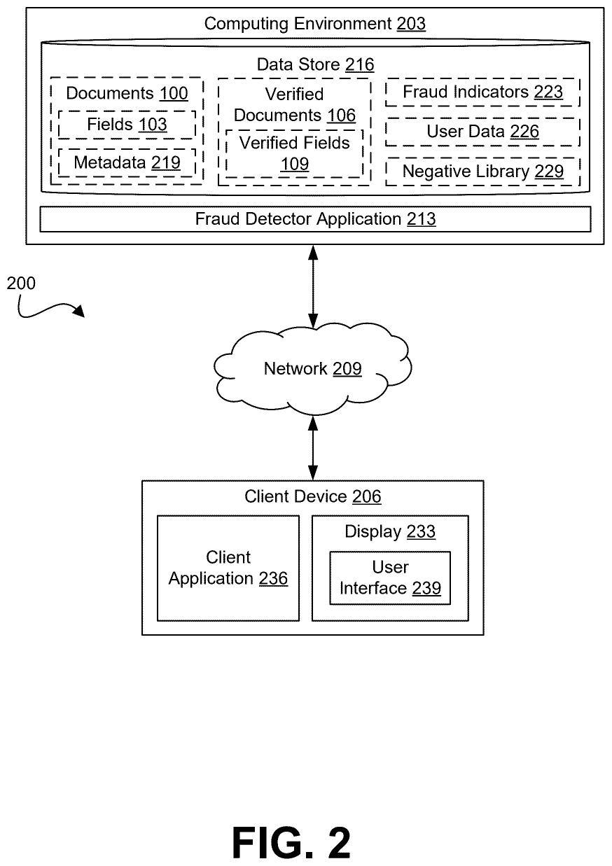

Referring next to FIGS. 3A and 3B, shown is a flowchart that provides one example of the operation of a portion of the fraud detector application 213. The flowchart of FIGS. 3A and 3B provides merely an example of the many different types of functional arrangements that can be employed to implement the operation of the depicted portion of the fraud detector application 213. As an alternative, the flowchart of FIGS. 3A and 3B can be viewed as depicting an example of elements of a method implemented within the network environment 200.

Beginning with block 300, the fraud detector application 213 can be executed to receive a document 100. The fraud detector application 213 can receive a document 100 from a user through a client application 236. In some examples, the fraud detector application 213 can obtain the document 100 from a data store 216 based at least in part on receiving a notification that a user has uploaded the document 100.

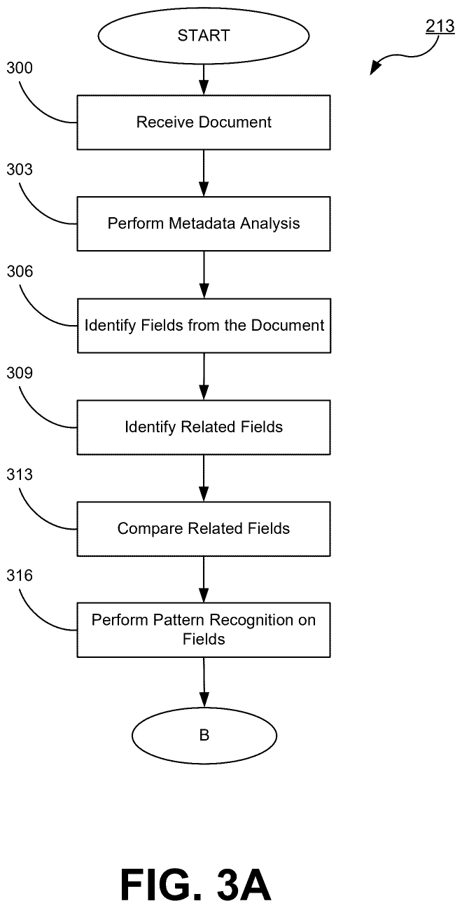

Next, with block 303, the fraud detector application 213 can be executed to perform a metadata analysis of the document 100. The fraud detector application 213 can extract metadata 219 from the document 100 received at block 300 and perform a variety of object checks. In some examples, the fraud detector application 213 can identify a number of fraud indicators 223 based at least in part on the metadata analysis. The metadata analysis of block 303 is described in greater detail in the discussion of FIG. 4.

At block 306, the fraud detector application 213 can be executed to identify fields 103 from the document 100. The fraud detector application 213 can use a computer vision algorithm (e.g., an Optical Character Recognition (OCR) algorithm, an image classification algorithm, an image segmentation algorithm, an object detection algorithm, etc.) to detect one or more fields 103 from within the document 100 received at block 300. In addition to identifying a location and the bounds of a field 103, the fraud detector application 213 can identify various metadata 219 about the fields 103 as well. For example, the fraud detector application 213 can identify a font, layout, alignment, contents, etc. of each of the fields 103. In some examples, the fraud detector application 213 can analyze each of the fields 103 for variations, inconsistencies, discrepancies, or other fraud indicators 223.

Next, at block 309, the fraud detector application 213 can be executed to identify related fields 103. The fraud detector application 213 can identify related fields 103 from within the document 100 by determining which fields 103 should contain related information. In some examples, the fraud detector application 213 can evaluate the contents of the fields 103 identified at block 306 to determine which fields 103 should be related. For example, the fraud detector application 213 can identify that a header field 103 and a table field 103 both contain a title of “Account Number” followed by a string of digits. Accordingly, the fraud detector application 213 can then identify that the header field 103 and the table field 103 are related fields 103. In another example, the fraud detector application 213 can identify that one field 103 corresponds to credits and debits for an account and another field 103 which corresponds to a total balance. The fraud detector application 213 can determine that the credit and debit field 103 is related to the total balance field 103 and identify both as related fields 103.

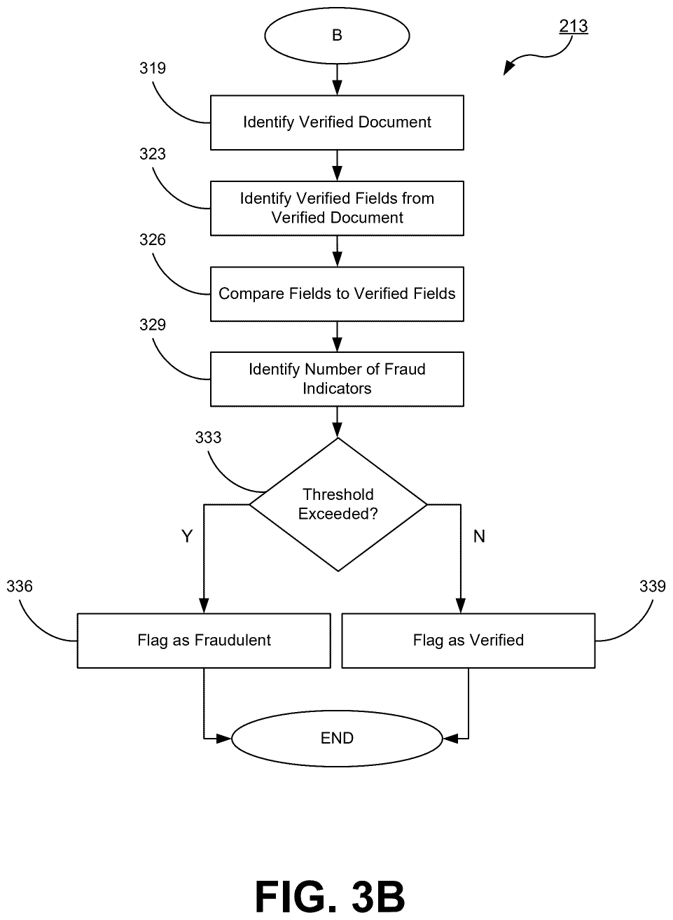

At block 313, the fraud detector application 213 can be executed to compare contents of related fields 103. The fraud detector application 213 can compare the contents of the related fields 103 identified at block 309. For example, the fraud detector application 213 can compare a related header field 103 and a table field 103 to determine whether an account number appearing in both fields is consistent. In another example, the fraud detector application 213 can compare a credit and debit field 103 of a table to a total balance field 103 of the table, calculate an anticipated total balance, and compare the results to the total balance field 103 to determine whether the fields are consistent. In some examples, the related fields 103 can be compared to determine whether fonts, alignment, contents, etc. are consistent. Inconsistencies, discrepancies, variations, or other differences can be fraud indicators 223. Additional description of the comparison of related fields 103 is found in the discussion of FIG. 5.

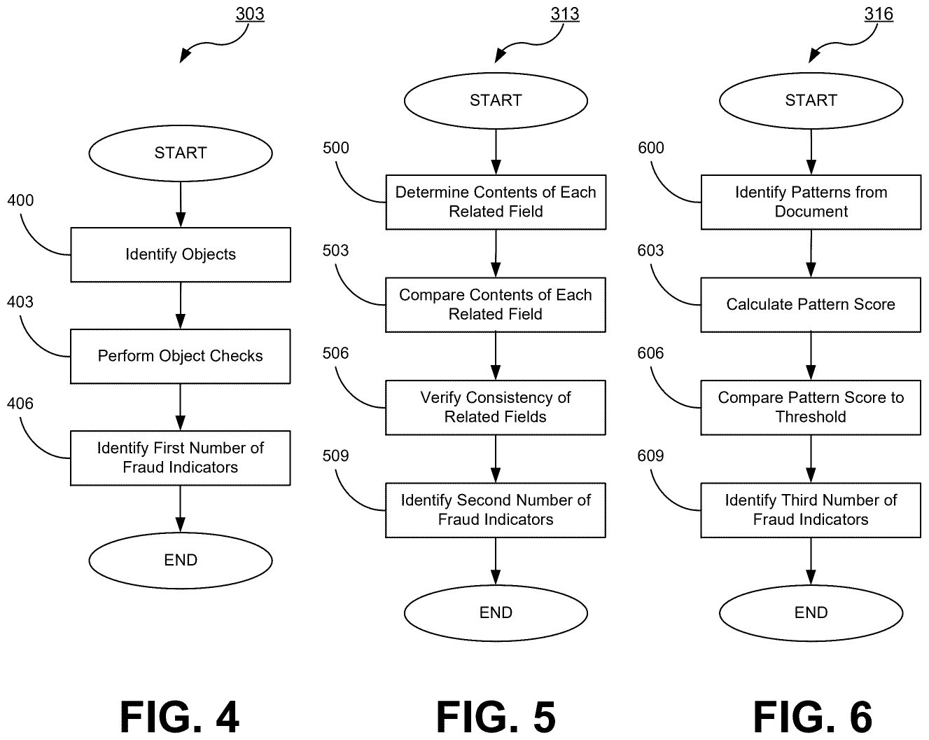

At block 316, the fraud detector application 213 can be executed to perform pattern recognition on fields 103. The fraud detector application 213 can use various text-processing techniques to determine the contents of a document 100. Next, the fraud detector application 213 can analyze the contents of the document 100 to search for and identify patterns in the contents. In some examples, the pattern recognition can yield another number of fraud indicators 223 identified by the fraud detector application 213. For example, the fraud detector application 213 can perform pattern recognition by identifying a pattern, determining a pattern length and the number of repeats, and calculate a pattern score. In some embodiments, the pattern score is calculated by dividing the number of fields 103 having patterns by the total number of fields 103 in a document 100. If the pattern score exceeds a threshold, the fraud detector application 213 can use the pattern score as a fraud indicator 223. Further details about the performance of pattern recognition can be found in the discussion of FIG. 6. After block 316, the flowchart of FIG. 3A moves to “B”which is shown in FIG. 3B.

Next, in FIG. 3B, the flowchart of FIG. 3A continues. At block 319, the fraud detector application 213 can be executed to identify a verified document 106. In some examples, the fraud detector application 213 can identify a verified document 106 based at least in part on the identification of fields 103 at block 306. The fraud detector application 213 can use the fields 103 to search a data store 216 for a similar verified document 106. The verified document 106 can have a similar layout of verified fields 109 as the layout of the fields 103 in the document 100. In some examples, the verified document 106 can be identified by the fraud detector application 213 based at least in part on the metadata analysis performed at block 303. For example, the fraud detector application 213 can identify a verified document 106 which corresponds to the document 100 by determining that at least one object of the document 100 identified at block 303 corresponds to an object of the verified document 106.

At block 323, the fraud detector application 213 can be executed to identify verified fields 109 from the verified document 106. Similarly to the process of identifying fields 103 from the document 100 described at block 306, the fraud detector application 213 can identify one or more verified fields 109 from the verified document 106 identified at block 319. The fraud detector application 213 can use a computer vision algorithm (e.g., an Optical Character Recognition (OCR) algorithm, an image classification algorithm, an image segmentation algorithm, an object detection algorithm, etc.) to detect one or more verified fields 109 from within the verified document 106. The fraud detector application 213 can identify a location and the bounds of a verified field 109, as well as identify various metadata 219 about the verified fields 109. For example, the fraud detector application 213 can identify a font, layout, alignment, contents, etc. of each of the verified fields 109.

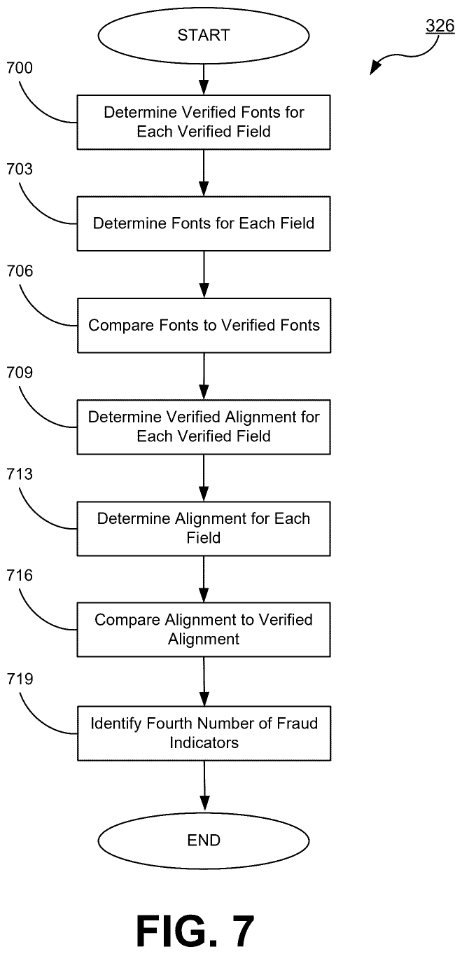

Next, at block 326, the fraud detector application 213 can be executed to compare fields 103 to verified fields 109. The fraud detector application 213 can use the verified fields 109 identified at block 323 to compare to the fields 103 of the document 100 identified at block 306 in order to identify differences, discrepancies, variations, patterns, or other fraud indicators 223. In some examples, the fraud detector application 213 can comparing the font, layout, alignment, contents, etc. of the verified fields 109 to the fields 103. The comparison of fields 103 to verified fields 109 is described in greater detail in the discussion of FIG. 7.

At block 329, the fraud detector application 213 can be executed to identify a number of fraud indicators 223. As discussed above, many of the blocks of the flowchart of FIGS. 3A and 3B can result in the identification of a fraud indicator 223. In some examples, the fraud detector application 213 identifies a number of fraud indicators 223 at each step of the analysis. The number of fraud indicators 223 can be zero at any step of the analysis or can be a non-zero integer. In block 329, the fraud detector application 213 can identify a total number of fraud indicators 223 based at least in part on the number of fraud indicators 223 previously identified in the analysis. In some examples, the total number of fraud indicators 223 can be zero. In some examples, the total number of fraud indicators 223 can be a non-zero integer.

At block 333, the fraud detector application 213 can be executed to determine if a document 100 is fraudulent by determining whether a threshold has been exceeded. The fraud detector application 213 can compare the number of fraud indicators 223 identified at block 329 to a threshold of fraud indicators 223 in order to determine whether the threshold has been exceeded. In some examples, the threshold is zero. In some examples, the threshold is a non-zero integer. The threshold can be a pre-set value or determined based at least in part on a number of fraud indicators 223 associated with fraudulent documents in a negative library 229. In some examples, the fraud detector application 213 can determine that the threshold is met, but not exceeded.

If the threshold has been exceeded at block 333, the flowchart can proceed to block 336, where the fraud detector application 213 can be executed to flag the document 100 as fraudulent. In some examples, the fraud detector application 213 can flag the document 100 as fraudulent based at least in part on the determination that the threshold was exceeded at block 333. In some examples, the number of fraud indicators 223 meets the threshold and the fraud detector application 213 flags the document 100 as fraudulent. The fraud detector application 213 can send a message or notification to a client application 236 that the document 100 submitted is fraudulent. After block 336, the flowchart of FIG. 3B can end.

If the threshold has not been exceeded at block 333, the flowchart can proceed to block 339, where the fraud detector application 213 can be executed to flag the document 100 as verified. In some examples, the fraud detector application 213 can flag the document 100 as verified based at least in part on the determination that the threshold was not exceeded at block 333. In some examples, the number of fraud indicators 223 meets the threshold, but does not exceed the threshold, and the fraud detector application 213 flags the document 100 as verified. The fraud detector application 213 can send a message or notification to a client application 236 that the document 100 submitted has been verified. After block 339, the flowchart of FIG. 3B can end.

Moving to FIG. 4, shown is a flowchart that provides one example of the operation of a portion of the fraud detector application 213. Specifically, the flowchart of FIG. 4 shows one example of how block 303 of FIG. 3A can be performed by the fraud detector application 213. The flowchart of FIG. 4 provides merely an example of the many different types of functional arrangements that can be employed to implement the operation of the depicted portion of the fraud detector application 213. As an alternative, the flowchart of FIG. 4 can be viewed as depicting an example of elements of a method implemented within the network environment 200.

At block 400, the fraud detector application 213 can be executed to identify objects. The fraud detector application 213 can begin a metadata analysis of the document 100 by identifying one or more objects from the metadata 219 of the document 100. In some examples, the objects can be binary objects. In some examples, the objects are representative of the metadata 219. According to various examples, the fraud detector application 213 can identify the objects from the document 100 received at block 300 from an xmp and/or xref table associated with the document 100.

At block 403, the fraud detector application 213 can be executed to perform object checks. The object checks can be representative of one or more metadata analyses performed on the document 100. For example, the fraud detector application 213 can perform an annotation analysis, checking for the presence of annotation tags in the objects from the document 100. Similarly, in some examples, the fraud detector application 213 can check for the presence of modified text (e.g., by determining whether the font name includes a “+” indicative of a change, and/or by identifying differences in words which indicated modified text). The fraud detector application 213 can further check the objects to determine whether the document 100 is a native document or scanned. For example, this check can be performed by analyzing the pixel-level dimensions of the submitted document to determine whether the document 100 matches a predefined size for a native document or varies from the predefined size, indicating the document 100 is a scanned image. Another example of an object check can be checking for duplicate objects within the document 100. A duplicate object can be a fraud indicator 223. Further examples of object checks include checking for hidden versions; checking dates of created or modified data to determine whether they are within an acceptable range of difference; checking the count/presence of a reference table to determine if it has been modified; cross-checking the objects of the document 100 against a negative library 229; and cross-checking the objects of the document 100 against historical document data to look for duplicates or deviations, as well as various other object checks. At block 406, the fraud detector application 213 can be executed to identify a first number of fraud indicators 223. According to various examples, the metadata analysis described in the flowchart of FIG. 4 can result in the identification of a number of fraud indicators 223. In examples where a metadata analysis is performed first, the number of fraud indicators 223 identified can be the first number of fraud indicators 223. The fraud detector application 213 can identify this number of fraud indicators 223 based at least in part on the object checks performed at block 403. After block 403, the flowchart of FIG. 4 ends.

Next, at FIG. 5, shown is a flowchart that provides one example of the operation of a portion of the fraud detector application 213. Specifically, the flowchart of FIG. 5 shows one example of how block 313 of FIG. 3A can be performed by the fraud detector application 213. The flowchart of FIG. 5 provides merely an example of the many different types of functional arrangements that can be employed to implement the operation of the depicted portion of the fraud detector application 213. As an alternative, the flowchart of FIG. 5 can be viewed as depicting an example of elements of a method implemented within the network environment 200.

To begin, at block 500, the fraud detector application 213 can be executed to determine the contents of each related field 103. The fraud detector application 213 can use various text-processing techniques to determine the contents from each of the related fields 103 identified at block 309 of FIG. 3A. The fraud detector application 213 can determine the text in a field 103, as well as various other data about the contents, such as font style, size, and type; alignment of text, tables, data in tables, and characters; consistency of contents; and other data.

Next, at block 503, the fraud detector application 213 can be executed to compare contents of each related field 103 to the other related fields 103. Based at least in part on the contents of the fields 103 identified at block 500, the fraud detector application 213 can compare the fonts, alignment, contents of each of the related fields 103. For example, if the related fields 103 are fields 103 which should both contain an account number, the fraud detector application 213 can compare the account number itself, as well as the font size and style, the alignment, and various other factors to identify inconsistencies.

At block 506, the fraud detector application 213 can be executed to verify the consistency of related fields 103. Once the related fields 103 have had their contents determined at block 500 and compared at block 503, the fraud detector application 213 can use the results of the comparison at block 503 to verify the consistency of the related fields 103. Based at least in part on the comparison of related fields 103, the fraud detector application 213 can determine whether any inconsistencies were identified. For example, if the related fields 103 should contain the same account number, the fraud detector application 213 can take the results of the comparison at block 503 to determine whether any inconsistencies were present. If inconsistencies exist across related fields 103, the fraud detector application 213 cannot verify the consistency, and in some examples, can mark the document 100 as inconsistent.

Moving to block 509, the fraud detector application 213 can be executed to identify a second number of fraud indicators 223. Based at least in part on the comparison of contents at block 503, and the verification of the consistency of the related fields 103 at block 506, the fraud detector application 213 can identify a number of fraud indicators 223. In some examples, the number of fraud indicators 223 identified can be the first, second, third, etc. number of fraud indicators 223. The fraud indicators 223 identified can be representative of inconsistencies resulting from the comparison of fields at block 503 and verified in block 509. In some examples, the number of fraud indicators 223 identified can be zero, but in other examples, the number of fraud indicators 223 identified can be a non-zero integer. After block 509, the flowchart of FIG. 5 comes to an end.

Next, at FIG. 6, shown is a flowchart that provides one example of the operation of a portion of the fraud detector application 213. Specifically, the flowchart of FIG. 6 shows one example of how block 316 of FIG. 3A can be performed by the fraud detector application 213. The flowchart of FIG. 6 provides merely an example of the many different types of functional arrangements that can be employed to implement the operation of the depicted portion of the fraud detector application 213. As an alternative, the flowchart of FIG. 6 can be viewed as depicting an example of elements of a method implemented within the network environment 200.

Beginning with block 600, the fraud detector application 213 can be executed to identify patterns from the document 100. As described in the discussion of block 316 in FIG. 3A, the fraud detector application 213 can use various text-processing techniques to determine the contents of a document 100. Next, the fraud detector application 213 can analyze the contents of the document 100 to search for and identify patterns in the contents. The fraud detector application 213 can search for and identify repeating numbers, whole numbers, repeating dates, repeating transactions, repeating descriptions, or other forms of patterns. For example, the fraud detector application 213 can determine that a document 100 includes an account statement having multiple lines of credits and debits to an account. The fraud detector application 213 can then search the credits and debits for repeating numbers or transactions, multiple transactions having whole numbers, multiple transactions with the same date, repeating patterns of credits and debits (e.g., credit-credit-debit, etc.), or other forms of patterns.

At block 603, the fraud detector application 213 can be executed to calculate a pattern score. The fraud detector application 213 can calculate a pattern score based at least in part on the number of patterns and/or number of occurrences of a pattern identified at block 600. In some embodiments, the pattern score is calculated by dividing the number of fields 103 having patterns by the total number of fields 103 in a document 100. For example, if the document 100 is an account summary comprising a list of credits and debits, the pattern score can be calculated by dividing the number of patterned credits/debits by the total number of credits and debits in the document 100.

Next, at block 606, the fraud detector application 213 can be executed to compare the pattern score to a threshold. In some examples, the fraud detector application 213 can compare the pattern score calculated at block 603 to a threshold. The threshold can be a pre-set threshold or determined based at least in part on pattern scores for fraudulent documents 100 in a negative library 229. The fraud detector application 213 can determine whether the pattern score exceeds the threshold or not.

Next, at block 609, the fraud detector application 213 can be executed to identify a third number of fraud indicators 223. In some examples, the number of fraud indicators 223 identified can be zero, but in other examples, the number of fraud indicators 223 identified can be a non-zero integer. Based at least in part on the pattern score calculated at block 603, and the comparison of the pattern score to the threshold at block 606, the fraud detector application 213 can identify a number of fraud indicators 223. For example, if four patterns or four occurrences of a pattern are identified in a document 100, the number of fraud indicators 223 identified by the fraud detector application 213 can be four. In some examples, if the pattern score exceeds the threshold, the pattern score can serve as a singular fraud indicator 223. In some examples, the number of fraud indicators 223 identified can be the first, second, third, etc. number of fraud indicators 223. After block 609, the flowchart of FIG. 6 comes to an end.

Next, at FIG. 7, shown is a flowchart that provides one example of the operation of a portion of the fraud detector application 213. Specifically, the flowchart of FIG. 7 shows one example of how block 326 of FIG. 3B can be performed by the fraud detector application 213. The flowchart of FIG. 7 provides merely an example of the many different types of functional arrangements that can be employed to implement the operation of the depicted portion of the fraud detector application 213. As an alternative, the flowchart of FIG. 7 can be viewed as depicting an example of elements of a method implemented within the network environment 200.

To begin, at block 700, the fraud detector application 213 can be executed to determine verified fonts corresponding to each verified field 109. Using computer text-processing techniques, such as optical character recognition (OCR) or other intelligent document-processing techniques, the fraud detector application 213 can detect a verified font size and style used in a verified field 109. In some embodiments, the verified font can be determined from the metadata 219 associated with the verified document 106.

At block 703, the fraud detector application 213 can be executed to determine fonts for each field 103. Similar to block 700, the fraud detector application 213 can use computer processing techniques, such as optical character recognition (OCR) or other intelligent document-processing techniques, to detect a font size and style used in a field 103. In some embodiments, the font can be determined from the metadata 219 associated with the document 100.

At block 706, the fraud detector application 213 can be executed to compare fonts to verified fonts based at least in part on the determination of verified fonts at block 700 and fonts at block 703. The fraud detector application 213 can compare the font (e.g., size, style, etc.) of alphanumerics within a field 103 to the verified font of alphanumerics within verified fields 109 of a verified document 106. In some examples, the fraud detector application 213 can compare each font of a field 103 to a respective verified font of a corresponding verified field 109. In some examples, a difference in fonts can be a fraud indicator 223.

Moving to block 709, the fraud detector application 213 can be executed to determine a verified alignment for each of the verified fields 109. The fraud detector application 213 can use computer vision techniques or intelligent document-processing techniques to detect a verified alignment of a verified field 109. In some examples, the verified alignment can be the alignment of the verified field 109 on a page, the alignment of characters in the verified field 109, or a relative alignment of the contents within the verified field 109.

Next, at block 713, the fraud detector application 213 can be executed to determine an alignment for each of the fields 103. Similar to the process described at block 709, the fraud detector application 213 can use computer vision techniques or intelligent document-processing techniques to detect an alignment of a field 103. In some examples, the alignment can be the alignment of the field 103 on a page, the alignment of characters in the field 103, or a relative alignment of the contents within the field 103.

Next, at block 716, the fraud detector application 213 can be executed to compare alignments for each of the fields 103 to verified alignments for each of the fields 103. The fraud detector application 213 can compare an alignment of alphanumerics in a given field 103 to a verified alignment of alphanumerics in a corresponding verified field 109. In some examples, the fraud detector application 213 can compare each alignment of each field 103 to a corresponding verified alignment of each verified field 109. In some instances, the fraud detector application 213 can detect a pixel-level difference in alignment. A difference between an alignment and a verified alignment can be a fraud indicator 223. Next, at block 719, the fraud detector application 213 can be executed to identify a fourth number of fraud indicators 223. Based at least in part on one or more of the earlier blocks, the fraud detector application 213 can identify a number of fraud indicators 223 which have been found in the document 100. In some examples, the number of fraud indicators 223 identified can be zero, but in other examples, the number of fraud indicators 223 identified can be a non-zero integer. Based at least in part on the comparison of fonts to verified fonts at block 706, and the comparison of alignments to verified alignments at block 716, the fraud detector application 213 can identify a number of fraud indicators 223. In some examples, the number of fraud indicators 223 identified can be the first, second, third, etc. number of fraud indicators 223. After block 719, the flowchart of FIG. 7 comes to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
identify with a machine learning algorithm one or more unverified fields from within an unverified document associated with an entity;
identify a verified document corresponding to the unverified document based at least in part on the entity;
compare the one or more unverified fields of the unverified document to one or more verified fields of the verified document; and
determine whether the unverified document is fraudulent based at least in part on a comparison of the one or more unverified fields to the one or more verified fields.

2. The system of claim 1, wherein the machine-readable instructions, when executed, further cause the computing device to at least:
identify one or more objects from within the unverified document; and
perform one or more object checks, each of the one or more object checks corresponding to a respective one of the one or more objects.

3. The system of claim 2, wherein the one or more object checks comprise at least one of an annotation check, a native document check, a duplicate object check, a modified text check, a hidden version check, a cross-reference table check, a date check, or a negative library check.

4. The system of claim 1, wherein the machine-readable instructions, when executed, further cause the computing device to at least:
determine a respective verified font for at least one of the one or more verified fields;
determine a respective unverified font for a corresponding one of the one or more unverified fields; and
compare the respective unverified font to the respective verified font.

5. The system of claim 1, wherein the machine-readable instructions, when executed, further cause the computing device to at least:
determine a respective verified alignment for each of the one or more verified fields;
determine a respective unverified alignment for each of the one or more unverified fields; and
compare each respective unverified alignment to each respective verified alignment.

6. The system of claim 1, wherein the machine-readable instructions, when executed, further cause the computing device to at least:
identify one or more related fields of the one or more unverified fields within the document, the one or more related fields comprising related information;
determine contents corresponding to each of the one or more related fields;
compare the contents for each of the one or more related fields; and
verify a consistency for each of the one or more related fields based at least in part on the comparison of the contents.

7. The system of claim 1, wherein the machine-readable instructions which, when executed, cause the computing device to determine whether the unverified document is fraudulent, further cause the computing device to at least:
identify a number of fraud indicators based at least in part on the comparison of the one or more unverified fields to the one or more verified fields; and
flag the unverified document as fraudulent based at least in part on the number of fraud indicators exceeding a threshold.

8. A method, comprising:
performing, by a machine learning algorithm on a computing device, a metadata analysis of an unverified document associated with an entity, the metadata analysis identifying a first number of fraud indicators;
identifying, by the machine learning algorithm, a verified document associated with the entity, the verified document corresponding to the unverified document;
identifying, by the machine learning algorithm, a second number of fraud indicators from within the unverified document based at least in part on a comparison of the unverified document to the verified document; and
flagging, by the machine learning algorithm, the unverified document as fraudulent based at least in part on the first number of fraud indicators and the second number of fraud indicators exceeding a threshold.

9. The method of claim 8, wherein identifying the second number of fraud indicators, further comprises:
identifying, by the machine learning algorithm, one or more unverified fields from within the unverified document;
comparing, by the machine learning algorithm, the one or more unverified fields of the unverified document to a corresponding one or more verified fields of the verified document; and
identifying, by the machine learning algorithm, a second number of fraud indicators based at least in part on the comparison of the one or more unverified fields.

10. The method of claim 9, wherein comparing the one or more fields to the one or more verified fields further comprises:
determining, by the machine learning algorithm, a respective verified font for at least one of the one or more verified fields;
determining, by the machine learning algorithm, a respective unverified font for a corresponding one of the one or more unverified fields; and
comparing, by the machine learning algorithm, the respective unverified font to the respective verified font.

11. The method of claim 9, wherein comparing the one or more unverified fields to the one or more verified fields further comprises:
determining, by the machine learning algorithm, a respective verified alignment for at least one of the one or more verified fields;
determining, by the machine learning algorithm, a respective unverified alignment for a corresponding one of the one or more unverified fields; and
comparing, by the machine learning algorithm, the respective unverified alignment to the respective verified alignment.

12. The method of claim 9, further comprising:
identifying, by the machine learning algorithm, one or more related fields of the one or more unverified fields within the unverified document, the one or more related fields comprising related information;
determining, by the machine learning algorithm, contents corresponding to each of the one or more related fields;
comparing, by the machine learning algorithm, the contents for each of the one or more related fields; and
verifying, by the machine learning algorithm, a consistency for each of the one or more related fields based at least in part on the comparison of the contents.

13. The method of claim 8, wherein performing the metadata analysis of the unverified document further comprises:
identifying, by the machine learning algorithm, one or more objects from the unverified document; and
performing, by the machine learning algorithm, one or more checks, each of the one or more checks corresponding to a respective one of the one or more objects.

14. The method of claim 8, further comprising:
identifying, by the machine learning algorithm, one or more patterns from within the unverified document;
calculating, by the machine learning algorithm, a pattern score based at least in part on the one or more patterns identified;
identifying, by the machine learning algorithm, a third number of fraud indicators based at least in part on the pattern score exceeding a threshold; and
flagging, by the machine learning algorithm, the unverified document as fraudulent based at least in part on the first number of fraud indicators, the second number of fraud indicators, and the third number of fraud indicators exceeding a threshold.

15. A non-transitory, computer-readable medium, comprising machine-readable instructions that, when executed by a processor of a computing device, cause the computing device to at least:
perform a metadata analysis of an unverified document associated with an entity, the metadata analysis identifying a first number of fraud indicators;
identify a verified document associated with the entity, the verified document corresponding to the unverified document;
identify a second number of fraud indicators from within the unverified document based at least in part on a comparison of the unverified document to the verified document; and
flag the unverified document as fraudulent based at least in part on the first number of fraud indicators and the second number of fraud indicators exceeding a threshold.

16. The non-transitory, computer-readable medium of claim 15, wherein the machine-readable instructions, when executed by the processor, further cause the computing device to at least:
identify one or more objects from the unverified document; and
perform one or more checks, each of the one or more checks corresponding to a respective one of the one or more objects.

17. The non-transitory, computer-readable medium of claim 15, wherein the machine-readable instructions which, when executed by the processor, cause the computing device to identify a second number of fraud indicators from within the unverified document, further cause the computing device to at least:
identify one or more unverified fields from within the unverified document;
compare the one or more unverified fields of the unverified document to a corresponding one or more verified fields of the verified document; and
identify a second number of fraud indicators based at least in part on the comparison of the one or more unverified fields.

18. The non-transitory, computer-readable medium of claim 15, wherein the machine-readable instructions, when executed by the processor, further cause the computing device to at least:
identify one or more patterns from within the unverified document;
calculate a pattern score based at least in part on the one or more patterns identified; and
identify a third number of fraud indicators based at least in part on the pattern score exceeding a threshold.

19. The non-transitory, computer-readable medium of claim 15, wherein the first number of fraud indicators comprises at least one of an annotation tag, a hidden version, or a modified text field.

20. The non-transitory, computer-readable medium of claim 15, wherein the second number of fraud indicators comprises at least one of a font inconsistency, an alignment inconsistency, or a content inconsistency.
